(19) United States
(12) Patent Application Publication
(10) Pub. No.: US 2023/0216082 A1
(43) Pub. Date: Jul. 6, 2023

(54) POLYELECTROLYTE COMPOSITES

(71) Applicant: Sepion Technologies, Inc., Emeryville, CA (US)

(72) Inventors: Andrew Ullman, Emeryville, CA (US); Jon-Michael Alessandro, Emeryville, CA (US); Peter D. Frischmann, Emeryville, CA (US)

(21) Appl. No.: 17/999,706

(22) PCT Filed: May 26, 2021
(86) PCT No.: PCT/US2021/034203

§ 371 Date: Nov. 22, 2022

Related U.S. Application Data
(60) Provisional application No. 63/030,439, filed on May 27, 2020.

(51) Int. Cl. H01M 10/056; H01M 10/0525

(52) U.S. Cl. CPC H01M 10/056; H01M 10/0525

(57) ABSTRACT

The present invention provides compositions including polyelectrolyte complexes. The composition includes: 1) an inorganic salt comprising a metal ion having a charge of at least +1 and an anion having a charge of at least −1; and 2) a complex comprising a first species and a second species, wherein the first species is a positively charged polymerizable monomer or a first charged polymer comprising one or more positively charged monomer repeat units; the second species is a negatively charged polymerizable monomer or a second charged polymer comprising one or more negatively charged monomer repeat units; and the complex has a net charge of near zero. These compositions are useful for ion selective applications in electrochemical devices.

### CROSS-REFERENCES TO RELATED APPLICATIONS

This application claims priority to U.S. Provisional Application No. 63/030,439, filed May 27, 2020, which is incorporated in its entirety herein for all purposes.

### STATEMENT OF GOVERNMENTAL SUPPORT

This invention was made with government support under Integration and Optimization of Novel Ion Conducting Solids (IONICS) DE-FOA-0001478 Award Number DE-AR0000774, awarded by the ARPA-E, U.S. Department of Energy. The government has certain rights in the invention.

### BACKGROUND OF THE INVENTION

Polyelectrolyte complexes (PECs) are a type of polymer composite formed when a positively charged polymer interacts with a negatively charged polymer, as shown in Equation 1. (Eq. 1), where Pol⁻, Pol⁺, M⁺, and A⁻ are the polyanion, polycation, salt cation, and salt anion respectively, and the species having subscript s are salts in a solution and species having subscript c are present in a complex.

(Pol⁺A⁻)ₛ+(Pol⁻M⁺)ₛ [symbol] (Pol⁺Pol⁻)_{c}+Mₛ⁺+Aₛ⁻ Eq. 1

These materials have been applied in numerous fields, including biomaterials, membrane separations, and energy storage devices. PECs can be formed by bulk precipitation, layer-by-layer adsorption, or by coating coacervate liquids. Most commonly, PECs are studied as thin films that are assembled via a layer-by-layer adsorption process. In those thin films, the sequential exposure of a surface to solutions of the charged polymers, with rinses between, leads to the controlled deposition of alternated layers. The thickness of the multilayer material is governed by many parameters including, polymer concentration, salt concentration, salt type, solvent type, and deposition time. The driving force of the formation of the polyelectrolyte complex is the entropy gained by the release of ions and solvent molecules to the bulk. In general, M⁺ and A⁻ are chosen for forming the corresponding salts due to high solubility in water, which facilitates their removal during the rinse steps.

For some PECs, it is known that the stoichiometry of the charged polymers is not perfectly one to one. After charge balancing, excess anions or cations remain in the film. For certain electrochemical devices, these excess ions pose a problem for long term stability in battery electrolytes, since they can diffuse to either the negative electrode or positive electrode leading to corrosion or metal plating.

There is a need to develop polyelectrolyte materials that have substantially reduced soluble anions or cations after charge balancing. The present disclosure addresses this need and provides related advantages as well.

### BRIEF SUMMARY OF THE INVENTION

In one embodiment, the present invention provides a composition comprising:
1) an inorganic salt comprising a metal ion having a charge of at least +1 and an anion having a charge of at least −1; and
2) a complex comprising a first species and a second species,
   wherein:
the first species is a positively charged polymerizable monomer or a first charged polymer comprising one or more positively charged monomer repeat units;
the second species is a negatively charged polymerizable monomer or a second charged polymer comprising one or more negatively charged monomer repeat units; and the complex has a net charge of near zero.

In another embodiment, the present invention provides an electrochemical device. The electrochemical device includes the composition as described herein in a separator; a separator coating, an electrode coating, an electrode binder, or combinations thereof.

### BRIEF DESCRIPTION OF THE DRAWINGS

FIG. 1 shows mass loading of the ink at various weight concentration of the LiF polyelectrolyte ink in the composition.

FIG. 2 shows comparison of discharge capacity versus numbers of cycles for coin cells, fabricated with either an uncoated separator or a separator coated with the composition of the present invention.

FIG. 3 shows the concentration (ppm) of transition metals found at the graphite anode for coin cells cycled with either an uncoated separator or a separator coated with the composition of the present invention.

### DETAILED DESCRIPTION OF THE INVENTION

### I. General

The present invention provides compositions including polyelectrolyte complexes. The compositions can be formed by reacting two components in an equal amount, where the first component includes a cationic polymer (or polymerizable monomer) and a counter anion (e.g., F⁻); and the second component includes an anionic polymer (or polymerizable monomer) and a counter cation (e.g., Li⁺). In particular, upon the interaction of the first and second components, the cation and anion (e.g., Li⁺ and F⁻) form strong ionic bonds leading to the formation of an inorganic salt (e.g., LiF). This method of forming polyelectrolyte complexes is unique and non-obvious because it utilizes a counter cation and counter anion pair which have a very low solubility. Therefore, the rinsing steps required to remove commonly used counter cations (Na⁺ and K⁺) and anions (Cl⁻ and Br⁻) is not required. Rather, the insoluble inorganic salt remain in the polyelectrolyte complex. These compositions are useful for ion selective applications in electrochemical devices.

The composition of the present invention provides several benefits: 1) the driving force provided by lithium fluoride precipitation facilitates the formation of the polyelectrolyte complexes; 2) the electrochemical inertness of lithium fluoride present in an electrochemical cell is well-tolerated and in some instances is beneficial; 3) since the counter ions (e.g., Li⁺ and F⁻) do not have to be removed, it reduces manufacturing cost by not requiring steps of washing away these ions; 4) the polyelectrolyte complexes (PECs) can now be prepared from starting materials including a charged polymer and charged monomer; and 5) it reduces excess charged species after charge balancing and in some instance the composition has a net charge of near zero, therefore providing long term stability in battery electrolytes.

### II. Definitions

“Electrolyte” refers to a solution of the electrochemical cell that includes ions, such as metal ions and protons as well as anions, that provides ionic communication between the positive and negative electrodes.

“Coacervate” refers to organic-rich droplets formed via liquid-liquid phase separation, mainly resulting from association of oppositely charged molecules (e.g., polyelectrolytes).

“Metal ion” refers to a positively charged ion of an element in the periodic table that is metallic. Metal ions useful in the present invention include alkali metal cations and alkali earth metal cations. Alkali metal cations useful in the present invention include Li⁺, Na⁺, K⁺, and Cs⁺. Alkali earth metal cations useful in the present invention include Be²⁺, Mg²⁺, Ca²⁺, Sr²⁺, and Ba²⁺.

“Anion” refers to an ion with more electrons than protons, resulting in a net negative charge. Anions useful in the present invention include halides, such as fluoride (F⁻), chloride (Cl⁻), bromide (Br⁻), and iodide (I⁻).

“Polymer” refers to a molecule composed of at least about 5 repeated subunits or monomers and having a molecular weight typically greater than 1000 Daltons. Polymers can be classified as naturally occurring or synthetic. Polymers useful in the present invention includes positively charged polymers, negatively charged polymers, amphiphilic polymers, or cross-linked polymers, each of which is defined herein.

“Copolymer” refers to a polymer comprising two or more monomers. Copolymers are classified based on the arrangement of the monomer units along the chain. Copolymers of the present invention can be linear or branched copolymers. Linear copolymers have a single main chain and include, but are not limited to, alternating copolymers, block copolymers, and statistical copolymers. Alternating copolymers have regular alternating A and B monomer units, and is often described by the formula -(-A-B-)ₙ-, wherein n is an integer. Block copolymers comprise two or more homopolymer subunits covalently linked together. For example, diblock copolymers have two distinct homopolymer subunits and triblock copolymers have three homopolymer subunits. Statistical copolymers comprise a sequence of monomer residues, and are commonly referred to as random copolymers. Branched copolymers have a single main chain with one or more polymeric side chains, and include, but are not limited to, grafted copolymers, and star shaped copolymers. Grafted copolymers have a main chain formed from one type of monomer and branches are formed from a second monomer. Star shaped copolymers have multiple polymer chains connected to a center core.

“Positively charged polymer” refers to a polymer that includes one or more positively charged monomer repeat units and an overall positive charge. Positively charged polymers useful in the present invention include, but are not limited to, poly(diallyldimethylammonium) (PDADMA), poly(vinylbenzyltrimethylammonium) (PVBTA), poly(acryloxyethyltrimethyl ammonium), poly(methacryloxy(2-hydroxy)propyltrimethyl ammonium), poly(N-methylvinylpyridinium) (PMVP), poly(N-methyl-2-vinylpyridinium) (PM2VP), poly(N-alkylvinylpyridinium), poly(allylamine) (PAH), polyethyleneimine (PEI), and copolymers thereof. One of skill in the art will appreciate that other types of positively charged polymer are useful in the present invention.

“Negatively charged polymer” refers to a polymer that includes one or more negatively charged monomer repeat units and an overall negative charge. Negatively charged polymers useful in the present invention include, but are not limited to, poly(styrenesulfonate) (PSS), poly(-acrylamido-2-methyl-1-propane sulfonate) (PAMPS), sulfonated poly(ether ether ketone) (SPEEK), poly(ethylenesulfonate), poly(methacryloxyethylsulfonate), poly(acrylate) (PAA), poly(methacrylate), and copolymers thereof. One of skill in the art will appreciate that other types of negatively charged polymer are useful in the present invention.

“Amphiphilic polymer” refers to a polymer that includes equal numbers of one or more positively charged monomer repeat units and one or more negatively charged monomer repeat units, each of which is distributed throughout the polymer in a random, alternating, or block sequence, and having a net charge of zero. For examples, an amphiphilic polymer may include 100 randomly distributed styrene sulfonate repeat units (negative) and 100 diallyldimethylammonium chloride repeat units (positive), said polymer having a net charge of zero. The one or more positively or negatively charged monomer repeat units are as defined herein. One of skill in the art will appreciate that other types of amphiphilic polymers are useful in the present invention.

“Cross-linked polymer” refers to a polymer where a positively charged polymer is covalently linked to a negatively charged polymer through a crosslinker. The crosslinkers useful in the present invention include, but are not limited to alkylene, haloalkylene, bis(benzylidene) cyclohexanone derivatives, and stilbene derivatives. One of skill in the art will appreciate that other types of crosslinkers are useful in the present invention.

“Polymerizable monomer” refers to a repeated subunit or monomer that can be polymerized to form a polymer. Polymerizable monomers in the present invention include positively charged polymerizable monomers and negatively charged polymerizable monomers, each of which is defined herein.

“Positively charged polymerizable monomer” refers to a positively charged repeated subunit or monomer that can be polymerized to form a positively charged polymer, an amphiphilic polymer, or a cross-linked polymer, as defined above. Positively charged polymerizable monomers useful in the present invention include, but are not limited to, diallyldimethylammonium, vinylbenzyltrimethylammonium, acryloxyethyltrimethyl ammonium, methacryloxy(2-hydroxy)propyltrimethyl ammonium, N-methylvinylpyridinium, N-alkylvinylpyridines, allylaminium, and aziridinium. One of skill in the art will appreciate that other types of positively charged polymerizable monomers are useful in the present invention.

“Negatively charged polymerizable monomer” refers to a negatively charged repeated subunit or monomer that can be polymerized to form a negatively charged polymer, an amphiphilic polymer, or a cross-linked polymer, as defined above. Negatively charged polymerizable monomers useful in the present invention include, but are not limited to, styrenesulfonate, 2-acrylamido-2-methyl-1-propane sulfonate, sulfonated hydroquinone or difluorobenzophenone, ethylenesulfonate, methacryloxyethylsulfonate, acrylate, or methacrylate. One of skill in the art will appreciate that other types of negatively charged polymerizable monomers are useful in the present invention.

“Complex” refers to a molecular entity held together through an electrostatic association of two or more ionic component molecular entities. The association between the components is normally weaker than in a covalent bond. In particular, the ionic component molecular entities in the present invention refer to polymers or polymerizable monomers that are independently positively charged, negatively charged, or both positively and negatively charged.

The symbol “@” used herein, for example in any one of (LiF@Pol⁺Pol⁻)_{c}, (LiF@Mono⁺Pol⁻)_{c}, (LiF@Pol⁻Mono⁺)_{c}, and LiF@pDADMA-AMPS, refers to LiF particles as a part of the complex as defined above.

“Electrochemical device” refers to a device wherein an electric current is produced by a chemical reaction, wherein electrons are transferred directly between molecules and/or atoms in oxidation-reduction reactions.

“Electrode” refers to an electrically conductive material in a circuit that is in contact with a nonmetallic part of the circuit, such as the electrolyte. The electrode can be a positive electrode or cathode, the electrode where reduction occurs. The electrode can be a negative electrode or anode, the electrode where oxidation occurs.

“Separator” refers to an electrically insulating membrane between the positive and negative electrodes to provide electronic isolation. The separator also allows the ions to move between the positive and anode electrodes. The separator can include any suitable polymeric material that is electrically insulating and porous. The separator can include several layers including one or more membrane layers, and a membrane support material for the membrane layers.

“Membrane” refers to a layer that is permeable to a first species of the electrolyte while substantially impermeable to a second species of the electrolyte. The membrane can be of any suitable material that can provide the selective permeability, such as compositions of the present invention.

“Coating” refers to a covering that is applied to the surface of a separator, membrane, or an electrode. The coating can be of any suitable material, which is molecularly distinct from the surface to which it is applied; preferred coatings include compositions of the present invention.

“Electrode binder” refers to a material responsible for holding the active material particles within the electrode of a lithium-ion battery (LIB) together to maintain a strong connection between the electrode and the contacts. These binding materials are normally inert and have an important role in the manufacturability of the battery.

“Quaternary ammonium” refers to a quaternary ammonium cation having the formula:

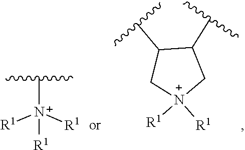

where each R¹ can be independently alkyl, haloalkyl, or aryl; or two R¹, together with the nitrogen atom to which they attach, can form heterocycloalkyl. Unlike the ammonium ion (NH₄⁺) and the primary, secondary, or tertiary ammonium cations, the quaternary ammonium cations are permanently charged, independent of the pH of their solution.

“Pyridinium” refers to a pyridine-containing cation having the formula:

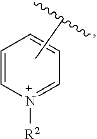

where R² can be alkyl, haloalkyl, alkoxy, aryl, aryl-alkyl, or heterocycloalkyl.

“Bipyridinium” refers to a bipyridine-containing cation having the formula:

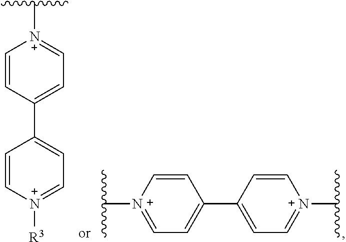

where R³ can be alkyl, haloalkyl, alkoxy, aryl, arylalkyl, or heterocycloalkyl.

“Imidazolium” refers to a imidazole-containing cation having the formula:

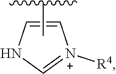

where R⁴ can be alkyl, haloalkyl, alkoxy, aryl, arylalkyl, or heterocycloalkyl.

“Protonated amine” refers to primary, secondary, or tertiary ammonium cations having the formula:

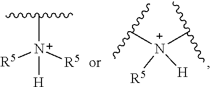

where each R⁵ can be independently hydrogen, alkyl, haloalkyl, or aryl; or two R⁵, together with the nitrogen atom to which they attach, can form heterocycloalkyl. Protonated amine cations are dependent of the pH of their solution.

“Sulfonium” refers to a sulfur-containing cation having the formula:

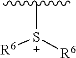

where each R⁶ can be independently alkyl, haloalkyl, or aryl.

“Phosphonium” refers to a phosphorous-containing cation having the formula:

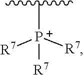

where each R⁷ can be independently halide, alkyl, haloalkyl, or aryl.

“Sulfonate” refers to a sulfur-containing anion having the formula:

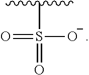 [SMILES: *S(=O)(=O)[O-]]

“Sulfonated poly(ether ether ketone)” or “SPEEK” refers to a polymer having one or more repeat units of —O—R^{a}—O—R^{b}—C(O)—R^{b}—, where R^{a} and R^{b} are each a 1,4-arylene group (e.g., 1,4-phenylene) and at least one of R^{a} and R^{b} has a sulfonate group as defined above. Exemplary SPEEKs include, but are not limited to, the polymer having the formula:

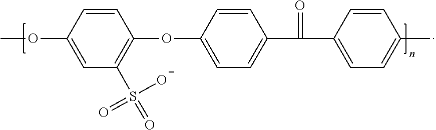

“Sulfate” refers to a sulfur-containing anion having the formula:

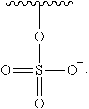 [SMILES: *OS(=O)(=O)[O-]]

“Carboxylate” refers to an anion having the formula:

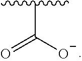 [SMILES: *C(=O)[O-]]

“Phosphate” refers to a phosphate-containing anion having the formula:

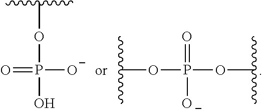 [SMILES: *OP(=O)([O-])O ; *OP(=O)([O-])O*]

“Polyphosphate” refers to a polymer including one or more repeat units of the phosphate as defined above. Exemplary polyphosphates include, but are not limited to, the polymer having the structure:

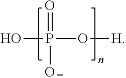

“Phosphonate” refers to a phosphate-containing anion having the formula:

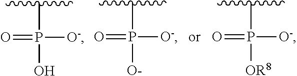

where R⁸ can be alkyl, haloalkyl, or aryl.

“Alkyl” refers to a straight or branched, saturated, aliphatic radical having the number of carbon atoms indicated (i.e., C₁₋₆ means one to six carbons). Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc.

“Haloalkyl” refers to alkyl, as defined above, where some or all of the hydrogen atoms are replaced with halogen atoms. As for alkyl group, haloalkyl groups can have any suitable number of carbon atoms, such as C₁-C₆. For example, haloalkyl includes trifluoromethyl, fluoromethyl, 2,2,2-trifluoroethyl, etc. In some instances, the term “perfluoro” can be used to define a compound or radical where all the hydrogens are replaced with fluorine. For example, perfluoromethyl refers to 1,1,1-trifluoromethyl.

“Alkoxy” refers to an alkyl group having an oxygen atom that connects the alkyl group to the point of attachment: alkyl-O—. Alkoxy groups can have any suitable number of carbon atoms, such as C₁-C₆. Alkoxy groups include, for example, methoxy, ethoxy, propoxy, iso-propoxy, butoxy, 2-butoxy, iso-butoxy, sec-butoxy, tert-butoxy, pentoxy, hexoxy, etc.

“Aryl” refers to an aromatic ring system having any suitable number of ring atoms and any suitable number of rings. Aryl groups can include any suitable number of ring atoms, such as, 6, 7, 8, 9, 10, 11, 12, 13, 14, 15 or 16 ring atoms, as well as from 6 to 10, 6 to 12, or 6 to 14 ring members. Aryl groups can be monocyclic, fused to form bicyclic or tricyclic groups, or linked by a bond to form a biaryl group. Representative aryl groups include phenyl, naphthyl and biphenyl. Other aryl groups include benzyl, having a methylene linking group. Some aryl groups have from 6 to 12 ring members, such as phenyl, naphthyl or biphenyl. Other aryl groups have from 6 to 10 ring members, such as phenyl or naphthyl. Some other aryl groups have 6 ring members, such as phenyl. Aryl groups can be substituted or unsubstituted.

“Aryl-alkyl” refers to a radical having an alkyl component and an aryl component, where the alkyl component links the aryl component to the point of attachment. The alkyl component is as defined above, except that the alkyl component is at least divalent, an alkylene, to link to the aryl component and to the point of attachment. The alkyl component can include any number of carbons, such as C₁₋₂, C₁₋₃, C₁₋₄, C₁₋₅, C₁₋₆, C₂₋₃, C₂₋₄, C₂₋₅, C₂₋₆, C₃₋₄, C₃₋₅, C₃₋₆, C₄₋₅, C₄₋₆ and C₅₋₆. The aryl component is as defined above. Examples of aryl-alkyl groups include, but are not limited to, benzyl. Aryl-alkyl groups can be substituted or unsubstituted.

“Heterocycle” or “heterocycloalkyl” refers to a saturated ring system having from 3 to 12 ring members and from 1 to 4 heteroatoms of N, O and S. The heteroatoms can also be oxidized, such as, but not limited to, —S(O)— and —S(O)₂—. Heterocycloalkyl groups can include any number of ring atoms, such as, 3 to 6, 4 to 6, 5 to 6, 3 to 8, 4 to 8, 5 to 8, 6 to 8, 3 to 9, 3 to 10, 3 to 11, or 3 to 12 ring members. Any suitable number of heteroatoms can be included in the heterocycloalkyl groups, such as 1, 2, 3, or 4, or 1 to 2, 1 to 3, 1 to 4, 2 to 3, 2 to 4, or 3 to 4. The heterocycloalkyl group can include groups such as aziridine, azetidine, pyrrolidine, piperidine, azepane, azocane, quinuclidine, pyrazolidine, imidazolidine, piperazine (1,2-, 1,3- and 1,4-isomers), oxirane, oxetane, tetrahydrofuran, oxane (tetrahydropyran), oxepane, thiirane, thietane, thiolane (tetrahydrothiophene), thiane (tetrahydrothiopyran), oxazolidine, isoxazolidine, thiazolidine, isothiazolidine, dioxolane, dithiolane, morpholine, thiomorpholine, dioxane, or dithiane. The heterocycloalkyl groups can also be fused to aromatic or non-aromatic ring systems to form members including, but not limited to, indoline. Heterocycloalkyl groups can be unsubstituted or substituted. For example, heterocycloalkyl groups can be substituted with C₁₋₆ alkyl or oxo (═O), among many others.

The heterocycloalkyl groups can be linked via any position on the ring. For example, aziridine can be 1- or 2-aziridine, azetidine can be 1- or 2- azetidine, pyrrolidine can be 1-, 2- or 3-pyrrolidine, piperidine can be 1-, 2-, 3- or 4-piperidine, pyrazolidine can be 1-, 2-, 3-, or 4-pyrazolidine, imidazolidine can be 1-, 2-, 3- or 4-imidazolidine, piperazine can be 1-, 2-, 3- or 4-piperazine, tetrahydrofuran can be 1- or 2-tetrahydrofuran, oxazolidine can be 2-, 3-, 4- or 5-oxazolidine, isoxazolidine can be 2-, 3-, 4- or 5-isoxazolidine, thiazolidine can be 2-, 3-, 4- or 5-thiazolidine, isothiazolidine can be 2-, 3-, 4- or 5- isothiazolidine, and morpholine can be 2-, 3- or 4-morpholine.

When heterocycloalkyl includes 3 to 8 ring members and 1 to 3 heteroatoms, representative members include, but are not limited to, pyrrolidine, piperidine, tetrahydrofuran, oxane, tetrahydrothiophene, thiane, pyrazolidine, imidazolidine, piperazine, oxazolidine, isoxzoalidine, thiazolidine, isothiazolidine, morpholine, thiomorpholine, dioxane and dithiane. Heterocycloalkyl can also form a ring having 5 to 6 ring members and 1 to 2 heteroatoms, with representative members including, but not limited to, pyrrolidine, piperidine, tetrahydrofuran, tetrahydrothiophene, pyrazolidine, imidazolidine, piperazine, oxazolidine, isoxazolidine, thiazolidine, isothiazolidine, and morpholine.

“N-linked heterocycloalkyl” or “nitrogen-linked heterocycloalkyl” refers to the heterocycloalkyl group linked via N-position on the ring. For example, N-linked aziridinyl is aziridin-1-yl, N-linked azetidinyl is azetidin-1-yl, N-linked pyrrolidinyl is pyrrolidin-1-yl, N-linked piperidinyl is piperidin-1-yl, N-linked pyrazolidinyl is pyrazolidin-1-yl or pyrazolidin-2-yl, N-linked imidazolidinyl can be imidazolidin-1-yl or imidazolidin-3-yl, N-linked piperazinyl is piperazin-1-yl or piperazin-4-yl, N-linked oxazolidinyl is oxazolidin-3-yl, N-linked isoxazolidiny is isoxazolidin-2-yl, N-linked thiazolidinyl is thiazolidin-3-yl, N-linked isothiazolidinyl is isothiazolidin-2-yl, and N-linked morpholinyl is 4-morpholinyl.

“Halide” refers to fluoride, chloride, bromide and iodide.

“Organic solvent” refers to water-miscible or water-immiscible solvents capable of dissolving either or both of water-soluble and water-insoluble organic compounds. Organic solvents useful in the present invention include, but are not limited to, chloroform, dichloroethane, dichloromethane, carbon tetrachloride, acetone, diethylether, and alcohols. Examples of alcohols useful in the present invention include, but are not limited to, methanol, ethanol, propanol, and isopropanol. One of skill in the art will appreciate that other organic solvents are useful in the present invention.

### III. Composition

In some embodiments, the present invention provides a composition comprising:
1) an inorganic salt including a metal ion having a charge of at least +1 and an anion having a charge of at least −1; and
2) a complex including a first species and a second species,
   wherein:
the first species is a positively charged polymerizable monomer or a first charged polymer including one or more positively charged monomer repeat units;
the second species is a negatively charged polymerizable monomer or a second charged polymer including one or more negatively charged monomer repeat units; and
the complex has a net charge of near zero.

In some embodiments, the composition includes:
1) an inorganic salt including a metal ion having a charge of at least +1 and an anion having a charge of at least −1; and
2) a complex including a first species and a second species,
   wherein:
the first species is a first charged polymer including one or more positively charged monomer repeat units;
the second species is a second charged polymer including one or more negatively charged monomer repeat units; and
the complex has a net charge of near zero.

In some embodiments, the composition includes:
1) an inorganic salt including a metal ion having a charge of at least +1 and an anion having a charge of at least −1; and
2) a complex including a first species and a second species,
   wherein:
the first species is a first charged polymer including one or more positively charged monomer repeat units;
the second species is a negatively charged polymerizable monomer; and
the complex has a net charge of near zero.

In some embodiments, the composition includes:
1) an inorganic salt including a metal ion having a charge of at least +1 and an anion having a charge of at least −1; and
2) a complex including a first species and a second species,
   wherein:
the first species is a positively charged polymerizable monomer;
the second species is a second charged polymer including one or more negatively charged monomer repeat units; and
the complex has a net charge of near zero.

In some embodiments, the inorganic salt includes a metal ion having a charge of +1 or +2; and an anion having a charge of −1. In some embodiments, the inorganic salt includes a metal ion having a charge of +1; and an anion having a charge of −1. In some embodiments, the inorganic salt includes a metal ion having a charge of +2; and an anion having a charge of −1.

In some embodiments, the metal ion is an alkali metal cation or an alkali earth metal cation. In some embodiments, the metal ion is an alkali metal cation. In some embodiments, the metal ion is an alkali earth metal cation. In some embodiments, the metal ion is Li⁺, Na⁺, K⁺, or Cs⁺. In some embodiments, the metal ion is Be²⁺, Mg²⁺, Ca²⁺, Sr²⁺, or Ba²⁺. In some embodiments, the metal ion is Li⁺.

In some embodiments, the anion is halide. In some embodiments, the anion is F⁻, Cl⁻, Br⁻, or I⁻. In some embodiments, the anion is F⁻.

In some embodiments, the inorganic salt includes an alkali metal cation or an alkali earth metal cation and halide. In some embodiments, the inorganic salt includes an alkali metal cation and halide. In some embodiments, the inorganic salt includes an alkali earth metal cation and halide. In some embodiments, the inorganic salt includes a cation and an anion, wherein the cation is Li⁺, Na⁺, K⁺, Cs⁺, Be²⁺, Mg²⁺, Ca²⁺, Sr²⁺, or Ba²⁺; and the anion is F⁻, Cl⁻, Br⁻, or I⁻. In some embodiments, the inorganic salt includes a cation and an anion, wherein the cation is Li⁺, Na⁺, K⁺, or Cs⁺; and the anion is F⁻, Cl⁻, Br⁻, or I⁻. In some embodiments, the inorganic salt includes a cation and an anion, wherein the cation is Li⁺, Na⁺, K⁺, or Cs⁺; and the anion is F⁻. In some embodiments, the inorganic salt is LiF.

In some embodiments, at least a portion of the inorganic salt is a plurality of particles. In some embodiments, at least a portion of LiF is a plurality of LiF particles.

In some embodiments, the first charged polymer includes one or more quaternary ammonium groups, pyridinium groups, bipyridinium groups, imidazolium groups, protonated amine groups, sulfonium groups, phosphonium groups, or combinations thereof.

In some embodiments, the quaternary ammonium group is represented by the formula:

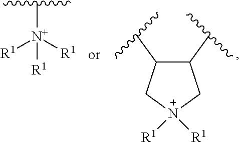

wherein each R¹ is independently C₁₋₆ alkyl, C₁₋₆ haloalkyl, or C₆₋₁₀ aryl; or two R¹, together with the nitrogen atom to which they attach, form a 3-8 membered heterocycloalkyl optionally having additional 1-2 heteroatoms independently selected from N, S, and O. In some embodiments, each R¹ is independently C₁₋₆ alkyl, C₁₋₆ haloalkyl, or C₆₋₁₀ aryl; or two R¹, together with the nitrogen atom to which they attach, form a 3-8 membered N-linked heterocycloalkyl. In some embodiments, each R¹ is independently C₁₋₆ alkyl, C₁₋₆ haloalkyl, or C₆₋₁₀ aryl. In some embodiments, each R¹ is independently C₁₋₆ alkyl or C₁₋₆ haloalkyl. In some embodiments, each R¹ is independently C₁₋₆ alkyl or C₆₋₁₀ aryl. In some embodiments, each R¹ is C₁₋₆ alkyl. In some embodiments, each R¹ is independently methyl, ethyl, propyl, butyl, pentyl, or hexyl. In some embodiments, each R¹ is methyl.

In some embodiments, the pyridinium group is represented by the formula:

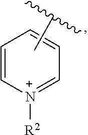

wherein R² is C₁₋₆ alkyl, C₁₋₆ haloalkyl, C₁₋₆ alkoxy, C₈₋₁₀ aryl, C₆₋₁₀ aryl-C₁₋₆ alkyl, or a 3-8 membered heterocycloalkyl optionally having additional 1-2 heteroatoms independently selected from N, S, and O. In some embodiments, R² is C₁₋₆ alkyl, C₁₋₆ haloalkyl, C₈₋₁₀ aryl, or C₆₋₁₀ aryl-C₁₋₆ alkyl. In some embodiments, R² is C₁₋₆ alkyl or C₁₋₆ haloalkyl. In some embodiments, R² is C₁₋₆ alkyl or C₈₋₁₀ aryl. In some embodiments, R² is C₁₋₆ alkyl. In some embodiments, R² is methyl, ethyl, propyl, butyl, pentyl, or hexyl. In some embodiments, R² is methyl.

In some embodiments, the bipyridinium group is represented by the formula:

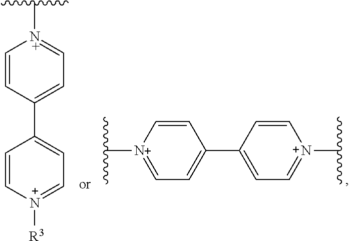

wherein R³ is C₁₋₆ alkyl, C₁₋₆ haloalkyl, C₁₋₆ alkoxy, C₈₋₁₀ aryl, C₆₋₁₀ aryl-C₁₋₆ alkyl, or a 3-8 membered heterocycloalkyl optionally having additional 1-2 heteroatoms independently selected from N, S, and O. In some embodiments, R³ is C₁₋₆ alkyl, C₁₋₆ haloalkyl, C₈₋₁₀ aryl, or C₆₋₁₀ aryl-C₁₋₆ alkyl. In some embodiments, R³ is C₁₋₆ alkyl or C₁₋₆ haloalkyl. In some embodiments, R³ is C₁₋₆ alkyl or C₈₋₁₀ aryl. In some embodiments, R³ is C₁₋₆ alkyl. In some embodiments, R³ is methyl, ethyl, propyl, butyl, pentyl, or hexyl. In some embodiments, R³ is methyl.

In some embodiments, the imidazolium group is represented by the formula:

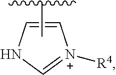

wherein R⁴ is C₁₋₆ alkyl, C₁₋₆ haloalkyl, C₁₋₆ alkoxy, C₈₋₁₀ aryl, C₆₋₁₀ aryl-C₁₋₆ alkyl, or a 3-8 membered heterocycloalkyl optionally having additional 1-2 heteroatoms independently selected from N, S, and O. In some embodiments, R⁴ is C₁₋₆ alkyl, C₁₋₆ haloalkyl, C₈₋₁₀ aryl, or C₆₋₁₀ aryl-C₁₋₆ alkyl. In some embodiments, R⁴ is C₁₋₆ alkyl or C₁₋₆ haloalkyl. In some embodiments, R⁴ is C₁₋₆ alkyl or C₈₋₁₀ aryl. In some embodiments, R⁴ is C₁₋₆ alkyl. In some embodiments, R⁴ is methyl, ethyl, propyl, butyl, pentyl, or hexyl. In some embodiments, R⁴ is methyl.

In some embodiments, the protonated amine group is represented by the formula:

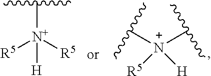

wherein each R⁵ is independently hydrogen, C₁₋₆ alkyl, C₁₋₆ haloalkyl, C₆₋₁₀ aryl; or two R⁵, together with the nitrogen atom to which they attach, form a 3-8 membered heterocycloalkyl optionally having additional 1-2 heteroatoms independently selected from N, S, and O. In some embodiments, each R⁵ is independently hydrogen, C₁₋₆ alkyl, C₁₋₆ haloalkyl, or C₆₋₁₀ aryl; or two R⁵, together with the nitrogen atom to which they attach, form a 3-8 membered N-linked heterocycloalkyl. In some embodiments, each R⁵ is independently hydrogen, C₁₋₆ alkyl, C₁₋₆ haloalkyl, or C₆₋₁₀ aryl. In some embodiments, each R⁵ is independently hydrogen, C₁₋₆ alkyl, or C₁₋₆ haloalkyl. In some embodiments, each R⁵ is independently hydrogen, C₁₋₆ alkyl or C₆₋₁₀ aryl. In some embodiments, each R⁵ is independently hydrogen or C₁₋₆ alkyl. In some embodiments, each R⁵ is independently hydrogen, methyl, ethyl, propyl, butyl, pentyl, or hexyl. In some embodiments, each R⁵ is hydrogen. In some embodiments, each R⁵ is methyl. In some embodiments, one R⁵ is hydrogen and the other R⁵ is methyl.

In some embodiments, the sulfonium group is represented by the formula:

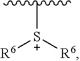

wherein each R⁶ is independently C₁₋₆ alkyl, C₁₋₆ haloalkyl, or C₆₋₁₀ aryl. In some embodiments, each R⁶ is independently C₁₋₆ alkyl or C₁₋₆ haloalkyl. In some embodiments, each R⁶ is independently C₁₋₆ alkyl or C₆₋₁₀ aryl. In some embodiments, each R⁶ is independently C₁₋₆ alkyl. In some embodiments, each R⁶ is independently methyl, ethyl, propyl, butyl, pentyl, or hexyl. In some embodiments, each R⁶ is methyl.

In some embodiments, the phosphonium group is represented by the formula:

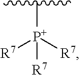

wherein each R⁷ is independently halide, C₁₋₆ alkyl, C₁₋₆ haloalkyl, or C₆₋₁₀ aryl. In some embodiments, each R⁷ is independently C₁₋₆ alkyl, C₁₋₆ haloalkyl, or C₆₋₁₀ aryl. In some embodiments, each R⁷ is independently C₁₋₆ alkyl or C₁₋₆ haloalkyl. In some embodiments, each R⁷ is independently C₁₋₆ alkyl or C₆₋₁₀ aryl. In some embodiments, each R⁷ is independently C₁₋₆ alkyl. In some embodiments, each R⁷ is independently methyl, ethyl, propyl, butyl, pentyl, or hexyl. In some embodiments, each R⁷ is methyl. In some embodiments, each R⁷ is phenyl.

In some embodiments, the first charged polymer includes one or more groups selected from the group consisting of:

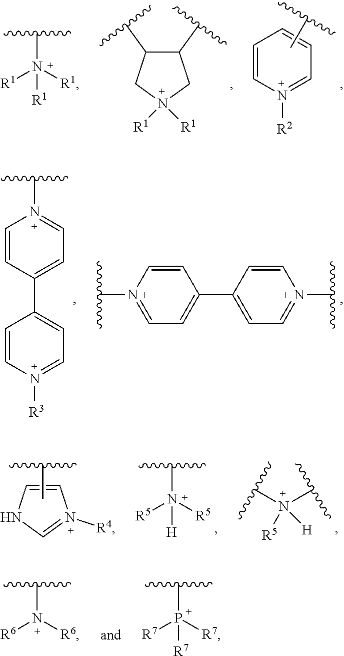

wherein each R¹, R²-R⁴, and each R⁵ to R⁷ are as defined and described herein. In some embodiments, the first charged polymer includes one or more groups selected from the group consisting of:

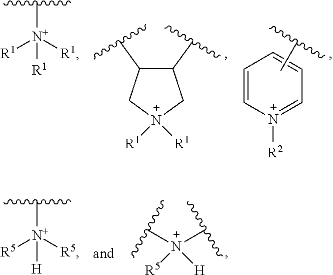

wherein each R¹, R², and each R⁵ are as defined and described herein. In some embodiments, the first charged polymer includes one or more groups selected from the group consisting of:

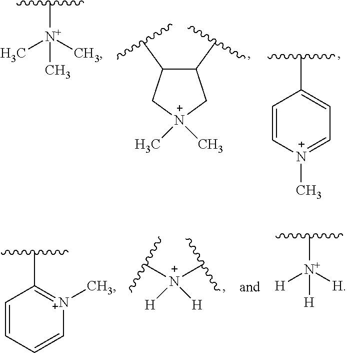

The first charged polymer used in the present invention may be copolymers that have a combination of positively charged and neutral monomer repeat units. Neutral monomer repeat units of the present invention include, but are not limited to, acrylamide, vinylpyrrolidone, vinylcaprolactam, and ethylene oxide, as shown below (where n represents numbers of repeat units):

| Name | Structure |
|---|---|
| acrylamide | 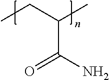 |
| vinylpyrrolidone | 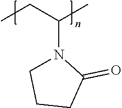 |
| ethylene oxide | 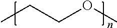 |
| vinylcaprolactam | 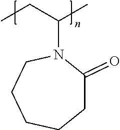 |

In some embodiments, the first charged polymer comprises one or more positively charged monomer repeat units in an amount of 20% to 90% by mole. In some embodiments, the first charged polymer comprises one or more positively charged monomer repeat units in an amount of from 30% to 90%, from 40% to 90%, from 50% to 90%, from 60% to 90%, from 70% to 90%, from 80% to 90%, from 20% to 80%, from 30% to 80%, from 40% to 80%, from 50% to 80%, from 60% to 80%, from 70% to 80%, from 20% to 70%, from 30% to 70%, from 40% to 70%, from 50% to 70%, from 60% to 70%, from 20% to 60%, from 30% to 60%, from 40% to 60%, from 50% to 60%, from 20% to 50%, from 30% to 50%, from 40% to 50%, from 20% to 40%, from 30% to 40%, or from 20% to 30% by mole. In some embodiments, the first charged polymer comprises one or more positively charged monomer repeat units in an amount of 60% to 90% by mole.

In some embodiments, the first charged polymer is poly(diallyldimethylammonium) (PDADMA), poly(vinylbenzyltrimethylammonium) (PVBTA), poly(acryloxyethyltrimethyl ammonium), poly(methacryloxy(2-hydroxy)propyltrimethyl ammonium), poly(N-methylvinylpyridinium) (PMVP), poly(N-alkylvinylpyridinium), poly(allylamine) (PAH), poly(ethyleneimine) (PEI), or copolymers thereof. In some embodiments, poly(N-methylvinylpyridinium) (PMVP) includes poly(N-methyl-2-vinylpyridinium) (PM2VP) and poly(N-methyl-4-vinylpyridinium) (PM4VP). In some embodiments, the first charged polymer is poly(diallyldimethylammonium).

Exemplary first charged polymers including one or more positively charged monomer repeat units are shown in Table 1 (where each of n, x, y represents numbers of repeat units).

TABLE 1
First Charged Polymers

| | Structure of |
|---|---|
| Polymer Name | Positively Charged Monomer Repeat Units |
| poly(diallyldimethylammonium) (PDADMA) | 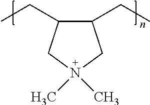 |
| poly(vinylbenzyltrimethylammonium) (PVBTA) | 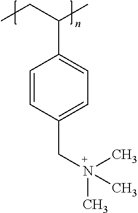 |
| poly(acryloxyethyltrimethyl ammonium) | 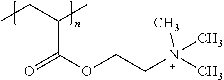 |
| poly(methacryloxy(2- hydroxy)propyltrimethyl ammonium) | 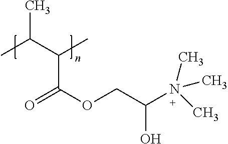 |
| poly(N-methyl-2-vinyl pyridinium) (PM2VP) | 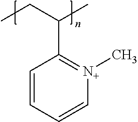 |
| poly(N-methyl-4-vinylpyridinium) (PM4VP) | 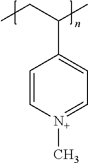 |
| poly(N-ethyl-4-vinylpyridinium) (PE4VP) | 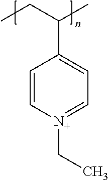 |
| poly(N-octyl-4-vinylpyridinium) (PNO4VP) | 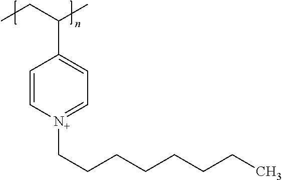 |
| poly(N-methyl-2-vinylpyridinium-co- ethyleneoxide) (PM2VP-co-PEO) | 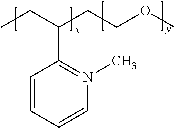 |
| poly(allylamine) (PAH) | 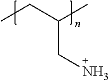 |
| poly(ethyleneimine) (PEI) | 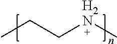 |

In some embodiments, the positively charged polymerizable monomer is diallyldimethylammonium, vinylbenzyltrimethylammonium, acryloxyethyltrimethyl ammonium, methacryloxy(2-hydroxy)propyltrimethyl ammonium, N-methylvinylpyridinium, N-alkylvinylpyridinium, allylaminium, or aziridinium. In some embodiments, N-methylvinylpyridinium includes N-methyl-2-vinylpyridinium and N-methyl-4-vinylpyridinium. In some embodiments, the positively charged polymerizable monomer is diallyldimethylammonium.

Exemplary positively charged polymerizable monomers are shown in Table 2.

TABLE 2
Positively Charged Polymerizable Monomers

| Monomer Name (Positively Charged) | Structure |
|---|---|
| diallyldimethylammonium (DADMA) | 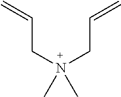 |
| vinylbenzyltrimethylammonium (VBTA) | 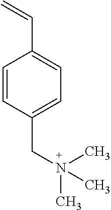 |
| acryloxyethyltrimethyl ammonium | 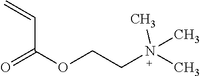 |
| methacryloxy(2-hydroxy)propyltrimethyl ammonium | 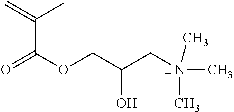 |
| N-methyl-2-vinyl pyridinium (M2VP) | 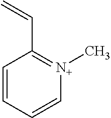 |
| N-methyl-4-vinylpyridinium (M4VP) | 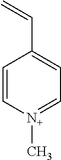 |
| N-ethyl-4-vinylpyridinium (E4VP) | 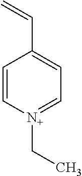 |
| N-octyl-4-vinylpyridinium (NO4VP) | 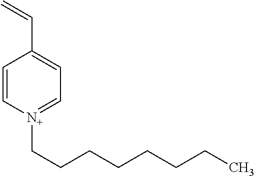 [SMILES: C=Cc1cc[n+](CCCCCCCC)cc1] |
| allylaminium | 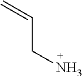 |
| aziridinium | 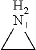 |

In some embodiments, the second charged polymer includes one or more sulfonate groups, carboxylate groups, phosphate groups, phosphonate groups, or combinations thereof.

In some embodiments, the second charged polymer includes one or more groups selected from the group consisting of:

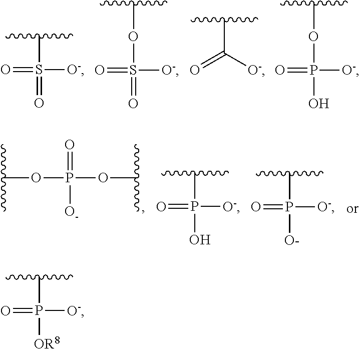

wherein R⁸ is C₁₋₆ alkyl, C₁₋₆ haloalkyl, or C₈₋₁₀ aryl. In some embodiments, R⁸ is C₁₋₆ alkyl or C₁₋₆ haloalkyl. In some embodiments, R⁸ is C₁₋₆ alkyl or C₈₋₁₀ aryl. In some embodiments, R⁸ is C₁₋₆ alkyl. In some embodiments, R⁸ is methyl, ethyl, propyl, butyl, pentyl, or hexyl. In some embodiments, R⁸ is methyl. In some embodiments, R⁸ is phenyl. In some embodiments, the second charged polymer includes one or more groups selected from the group consisting of:

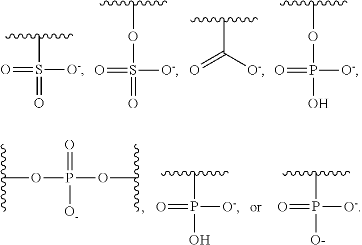

In some embodiments, the second charged polymer includes one or more groups selected from the group consisting of:

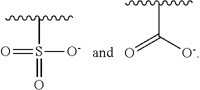

In some embodiments, the second charged polymer includes one or more groups selected from the group consisting of:

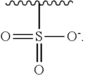

In some embodiments, the second charged polymer includes one or more groups selected from the group consisting of:

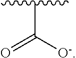

The second charged polymer used in the present invention may be copolymers that have a combination of negatively charged and neutral monomer repeat units. Neutral monomer repeat units of the present invention include, but are not limited to, acrylamide, vinylpyrrolidone, vinylcaprolactam, and ethylene oxide, as shown below (where n represents numbers of repeat units):

| Name | Structure |
|---|---|
| acrylamide | 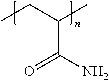 |
| vinylpyrrolidone | 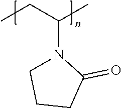 |
| ethylene oxide | 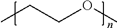 |
| vinylcaprolactam | 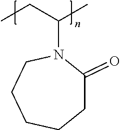 |

In some embodiments, the second charged polymer includes one or more negatively charged monomer repeat units in an amount of 20% to 80% by mole. In some embodiments, the second charged polymer includes one or more negatively charged monomer repeat units in an amount of from 30% to 80%, from 40% to 80%, from 50% to 80%, from 60% to 80%, from 70% to 80%, from 20% to 70%, from 30% to 70%, from 40% to 70%, from 50% to 70%, from 60% to 70%, from 20% to 60%, from 30% to 60%, from 40% to 60%, from 50% to 60%, from 20% to 50%, from 30% to 50%, from 40% to 50%, from 20% to 40%, from 30% to 40%, or from 20% to 30% by mole. In some embodiments, the first charged polymer comprises one or more positively charged monomer repeat units in an amount of 60% to 80% by mole.

In some embodiments, the second charged polymer is poly(styrenesulfonate) (PSS), poly(2-acrylamido-2-methyl-1-propane sulfonate) (PAMPS), sulfonated poly(ether ether ketone) (SPEEK), poly(ethylenesulfonate), poly(methacryloxyethylsulfonate), poly(acrylate) (PAA), poly(methacrylate), polyphosphates, polyphosphonates, or copolymers thereof. In some embodiments, the second charged polymer is poly(styrenesulfonate) (PSS), poly(2-acrylamido-2-methyl-1-propane sulfonate) (PAMPS), sulfonated poly(ether ether ketone) (SPEEK), poly(ethylenesulfonate), poly(methacryloxyethylsulfonate), poly(acrylate) (PAA), poly(methacrylate), or copolymers thereof. In some embodiments, the second charged polymer is poly(styrenesulfonate) (PSS). In some embodiments, the second charged polymer is poly(2-acrylamido-2-methyl-1-propane sulfonate) (PAMPS). In some embodiments, the second charged polymer is poly(acrylate) (PAA).

Exemplary second charged polymers including one or more negatively charged monomer repeat units are shown in Table 3 (where n represents numbers of repeat units).

TABLE 3
Second Charged Polymers

| | Structure of |
|---|---|
| Polymer Name | Negatively Charged Monomer Repeat Units |
| poly(styrenesulfonate) (PSS) | 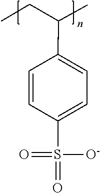 |
| poly(2-acrylamido-2-methyl-1-propane sulfonate) (PAMPS) | 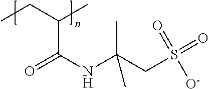 |
| exemplary sulfonated poly(ether ether ketone) (SPEEK) | 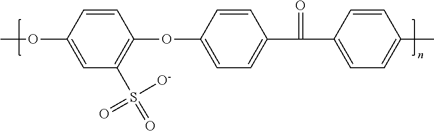 |
| poly(ethylenesulfonate) | 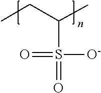 |
| poly(methacryloxyethylsulfonate) | 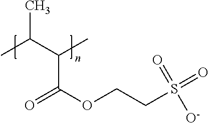 |
| poly(acrylate) (PAA) | 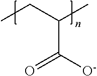 |
| poly(methacrylate) | 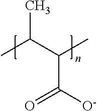 |

In some embodiments, the negatively charged polymerizable monomer is styrenesulfonate, 2-acrylamido-2-methyl-1-propane sulfonate, sulfonated hydroquinone or difluorobenzophenone, ethylenesulfonate, methacryloxyethylsulfonate, acrylate, or methacrylate. In some embodiments, the negatively charged polymerizable monomer is 2-acrylamido-2-methyl-1-propane sulfonate.

Exemplary negatively charged polymerizable monomers are shown in Table 4.

TABLE 4
Negatively Charged Polymerizable Monomers

| Monomer Name (Negatively Charged) | Structure |
|---|---|
| styrenesulfonate | 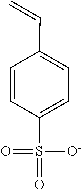 |
| 2-acrylamido-2-methyl-1-propane sulfonate | 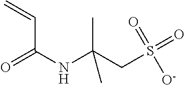 |
| exemplary sulfonated hydroquinone or difluorobenzophenone | 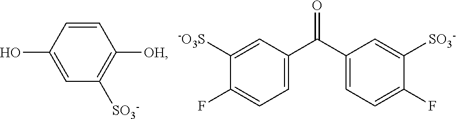 |
| ethylenesulfonate | 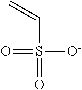 |
| methacryloxyethylsulfonate | 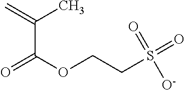 |
| acrylate | 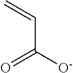 |
| methacrylate | 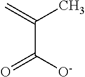 |

In some embodiments, the first charged polymer and the second charged polymer are each an amphiphilic polymer including one or more positively charged monomer repeat units and one or more negatively charged monomer repeat units, wherein the amphiphilic polymer has a net charge of zero. In some embodiments, the one or more positively or negatively charged monomer repeat units are defined and described according to the groups in the first and second charged polymers. In some embodiments, the one or more positively charged monomer repeat units are diallyldimethylammonium, vinylbenzyltrimethylammonium, acryloxyethyltrimethyl ammonium, methacryloxy(2-hydroxy)propyltrimethyl ammonium, N-methylvinylpyridinium, N-alkylvinylpyridinium, allylaminium, or aziridinium; and the one or more negatively charged monomer repeat units are styrenesulfonate, 2-acrylamido-2-methyl-1-propane sulfonate, sulfonated hydroquinone or difluorobenzophenone, ethylenesulfonate, methacryloxyethylsulfonate, acrylate, or methacrylate. In some embodiments, the one or more positively charged monomer repeat units are diallyldimethylammonium and the one or more negatively charged monomer repeat units are 2-acrylamido-2-methyl-1-propane sulfonate.

In some embodiments, each of the first and second charged polymers has at least about 5 repeat subunits or monomers. In some embodiments, each of the first and second charged polymers has at least about 10, 20, 30, 40, 50, 100, 1000, 5000, or 10,000 repeat subunits or monomers. In some embodiments, each of the first and second charged polymers has from about 10 to 25,000, from about 50 to 10,000, or from about 50 to 5000 repeat subunits or monomers. In some embodiments, each of the first and second charged polymers has from about 50 to 5000 repeat subunits or monomers. In some embodiments, each of the first and second charged polymers has a molecular weight of at least about 500 Daltons or 1000 Daltons. In some embodiments, each of the first and second charged polymers has a molecular weight of at least about 1000 Daltons. In some embodiments, each of the first and second charged polymers has a molecular weight of from about 1000 to 5,000,000 Daltons. In some embodiments, each of the first and second charged polymers has a molecular weight of from about 10,000 to 1,000,000 Daltons.

In some embodiments, the first charged polymer and second charged polymer are covalently cross-linked. In some embodiments, the first charged polymer and second charged polymer are covalently cross-linked through a cross-linker. Cross-linkers useful in the present invention include, but are not limited to, trimethylolpropane triacrylate, trimethylolpropane trimethacrylate, 1,4-butanediol diacrylate, 1 4-butanediol dimethacrylate, and pentaerythritol tetraacrylate. In some embodiments, the cross-linker is trimethylolpropane triacrylate, trimethylolpropane trimethacrylate, 1,4-butanediol diacrylate, 1 4-butanediol dimethacrylate, or pentaerythritol tetraacrylate.

In some embodiments, the composition includes:
1) a plurality of LiF particles; and
2) a complex including a first species and a second species,
   wherein:
the first species is a first charged polymer including one or more positively charged monomer repeat units;
the second species is a second charged polymer including one or more negatively charged monomer repeat units; and
the complex has a net charge of near zero,
   wherein the first and second charged polymers are defined and described herein.

In some embodiments, the first charged polymer is poly(diallyldimethylammonium); and the second charged polymer is poly(2-acrylamido-2-methyl-1-propane sulfonate) (PAMPS).

In some embodiments, the composition includes:
1) a plurality of LiF particles; and
2) a complex including a first species and a second species,
   wherein:
the first species is a first charged polymer including one or more positively charged monomer repeat units;
the second species is a negatively charged polymerizable monomer; and
the complex has a net charge of near zero,
   wherein the first charged polymer and the negatively charged polymerizable monomer are as defined and described herein.

In some embodiments, the first charged polymer is poly(diallyldimethylammonium); and the negatively charged polymerizable monomer is 2-acrylamido-2-methyl-1-propane sulfonate.

In some embodiments, The composition includes:
1) a plurality of LiF particles; and
2) a complex including a first species and a second species,
   wherein:
the first species is a positively charged polymerizable monomer;
the second species is a second charged polymer including one or more negatively charged monomer repeat units; and
the complex has a net charge of near zero,
   wherein the positively charged polymerizable monomer and the second charged polymer are defined and described herein.

In some embodiments, the positively charged polymerizable monomer is diallyldimethylammonium; and the second charged polymer is poly(2-acrylamido-2-methyl-1-propane sulfonate) (PAMPS).

In some embodiments, the composition includes:
1) a plurality of LiF particles; and
2) a complex comprising poly(diallyldimethylammonium) and 2-acrylamido-2-methyl-1-propane sulfonate,
   wherein the complex has a net charge of near zero.

In some embodiments, the composition of the present invention further includes an organic solvent. The organic solvent useful in the present invention includes, but is not limited to, chloroform, dichloroethane, dichloromethane, carbon tetrachloride, acetone, diethylether, and an alcohol. In some embodiments, the composition of the present invention further includes an alcohol. In some embodiments, the alcohol is methanol, ethanol, propanol, or isopropanol. In some embodiments, the composition of the present invention further includes methanol.

The composition of the present invention can be formed by reacting two components in an equal amount, where the first component includes a positively charged polymer or polymerizable monomer and a counter anion (e.g., F⁻); and the second component includes a negatively charged polymer or polymerizable monomer and a counter cation (e.g., Li⁺). Upon the interaction of the first and second components, the metal ion (e.g., Li⁺) and the anion (e.g., F⁻) form strong ionic bonds leading to the formation of the inorganic salt (e.g., LiF). The formation enthalpy of the inorganic salt (e.g., LiF) is coupled with the electrostatic attraction of the charged polymer components, ultimately leading to the composition of the present invention that includes both the inorganic salt (e.g., LiF) and a polyelectrolyte complex as a polymeric-inorganic composition.

In some embodiments, the composition including (LiF@Pol⁺Pol⁻)_{c} is formed by reacting two components in an equal amount according to Equation 2:

(Pol⁺F⁻)ₛ+(Pol⁻Li⁺)ₛ [symbol] (LiF@Pol⁺Pol⁻)_{c} Eq. 2

wherein the first component includes the first charged polymer (referred herein as the positively charged polymer) and fluoride (i.e., (Pol⁺F⁻)ₛ in solution); and the second component includes the second charged polymer (referred herein as the negatively charged polymer) and lithium (i.e., (Pol⁻Li⁺), in solution), wherein the first charged polymer and the second charged polymer are defined and described herein. In some embodiments, the first charged polymer is poly(diallyldimethylammonium); and the second charged polymer is poly(2-acrylamido-2-methyl-1-propane sulfonate) (PAMPS).

In some embodiments, the composition including (LiF@Mono⁺Pol⁻)_{c} is formed by reacting two components in an equal amount according to Equation 3:

(Mono⁺F⁻)ₛ+(Pol⁻Li⁺)ₛ [symbol] (LiF@Mono⁺Pol⁻)_{c} Eq. 3

wherein the first component includes the positively charged polymerizable monomer and fluoride (i.e., (Mono⁺F⁻)ₛ in solution); and the second component includes the second charged polymer (referred herein as the negatively charged polymer) and lithium (i.e., (Pol⁻Li⁺)ₛ in solution), wherein the positively charged polymerizable monomer and the second charged polymer are defined and described herein. In some embodiments, the positively charged polymerizable monomer is diallyldimethylammonium; and the second charged polymer is poly(2-acrylamido-2-methyl-1-propane sulfonate) (PAMPS).

In some embodiments, the composition including (LiF@Pol⁺Mono⁻)_{c} is formed by reacting two components in an equal amount according to Equation 4:

(Pol⁺F⁻)ₛ+(Mono⁻Li⁺)ₛ [symbol] (LiF@Pol⁺Mono⁻)_{c} Eq. 4

wherein the first component includes the first charged polymer (referred herein as the positively charged polymer) and fluoride (i.e., (Pol⁺F⁻)ₛ in solution); and the second component includes the negatively charged polymerizable monomer and lithium (i.e., (Mono⁻Li⁺)ₛ in solution), wherein the first charged polymer and the negatively charged polymerizable monomer are defined and described herein. In some embodiments, the first charged polymer is poly(diallyldimethylammonium); and the negatively charged polymerizable monomer is 2-acrylamido-2-methyl-1-propane sulfonate.

### IV. Application

The precursor inks including the composition as described herein can be used in standard coating (doctor-blade, spin-coat, wire rod, etc.) and curing (thermal, UV) techniques. In particular, the composition of the present invention is useful in an electrochemical device, for example can be applied in a separator; a separator coating, an electrode coating, an electrode binder, or combinations thereof

In some embodiments, the present invention provides an electrochemical device including a composition as described herein in a separator; a separator coating, an electrode coating, an electrode binder, or combinations thereof.

In some embodiments, the electrochemical device is an electrochemical cell. In some embodiments, an electrochemical cell includes a positive electrode, a negative electrode, a separator, and an electrolyte. The separator is disposed between the positive electrode and the negative electrode. The separator provides electronic isolation between the positive electrode and the negative electrode. The selective permeability of a separator is achieved by its specific composition and morphology. Specifically, a species responsible for desirable ion transport in an electrochemical cell is allowed to pass through the separator, while another species is blocked thereby preventing degradation of the cell. For example, a species including alkali metal cations, such as lithium ions or sodium ions, is allowed to pass through the separator in rechargeable cells, while electrolyte solvent and other species are blocked. The electrolyte includes a first species and electrolyte solvent, where the first species includes alkali metal cations (e.g., Li⁺) and an anion (e.g., PF₆⁻), other ions or ion pairs known in the art; and the electrolyte solvent is any liquid known in the art that solvates the first species. At least a portion of the electrolyte is disposed within the separator. The separator, with at least the portion of the electrolyte disposed within, is permeable to the first species providing ionic communication between the positive electrode and the negative electrode. The separator, with at least the portion of the electrolyte disposed within, is substantially impermeable to the electrolyte solvent.

The separator includes a first membrane layer. The first membrane layer may be a standalone layer, supported by a membrane support, or supported by one of the electrodes.

In some embodiments, the separator further comprises a membrane support laminated to the first membrane layer. The membrane support is permeable to the electrolyte solvent. The membrane support may be a porous polymer selected from the group consisting of polypropylene and polyethylene. The average pore diameter of the membrane support is at least about 10 nanometers. The first membrane layer may be disposed between the membrane support and the negative electrode.

In some embodiments, the separator further comprises a second membrane layer laminated to the membrane support. The membrane support may be disposed between the first membrane layer and the second membrane layer. The first membrane layer may be permeable to the first species providing ionic communication between the positive electrode and the negative electrode, and wherein the first membrane layer is substantially impermeable to liquid electrolyte. In some embodiments, the second membrane layer includes a ceramic material selected from the group consisting of aluminum oxide, silicon oxide, silicon carbide, titanium dioxide, magnesium oxide, tin oxide, cerium oxide, zirconium oxide, barium titanate, yttrium oxide, boron nitride, and an ion conducting ceramic.

In some embodiments, the first membrane layer directly interfaces the negative electrode and the positive electrode.

In some embodiments, the composition of the present invention can be used in a separator, an electrode, an electrode binder, or combinations thereof. In some embodiments, the composition of the present invention can be used as a coating in a separator and/or an electrode. In some embodiments, the composition of the present invention can be used in a separator. In some embodiments, the composition of the present invention can be used as a coating in a separator. In some embodiments, the composition of the present invention can be used as a coating for an electrode. In some embodiments, the composition of the present invention can be used in an electrode binder. In some embodiments, the composition of the present invention can be coated onto a separator and/or an electrode. In some embodiments, the composition of the present invention can be coated onto a separator. In some embodiments, the composition of the present invention can be coated onto an electrode. In some embodiments, the composition of the present invention can be coated onto a separator and an electrode.

In some embodiments, the present invention provides an electrochemical device including a separator and an electrode, at least one of which is coated with the composition as defined and described herein. In some embodiments, the present invention provides an electrochemical device including a separator and an electrode, each of which is coated with the composition as defined and described herein.

In some embodiments, the composition including (LiF@Pol⁺Pol⁻)_{c}, (LiF@Mono⁺Pol⁻)_{c} or (LiF@Pol⁺Mono⁻)_{c}), as described above can be used in an electrochemical device, for example can be applied in a separator; a separator coating, an electrode coating, an electrode binder, or combinations thereof. In some embodiments, the composition including (LiF@Pol⁺Pol⁻)_{c}, (LiF@Mono⁺Pol⁻)_{c} or (LiF@Pol⁺Mono⁻)_{c}), as described above can be coated onto a separator and/or an electrode. In some embodiments, the composition including (LiF@Pol⁺Pol⁻)_{c}, (LiF@Mono⁺Pol⁻)_{c} or (LiF@Pol⁺Mono⁻)_{c}), as described above can be coated onto a separator. In some embodiments, the composition including (LiF@Po⁺Pol⁻)_{c}, (LiF@Mono⁺Pol⁻)_{c} or (LiF@Pol⁺Mono⁻)_{c}), as described above can be coated onto an electrode. In some embodiments, the composition including (LiF@Pol⁺Pol⁻)_{c}, (LiF@Mono⁺Pol⁻)_{c} or (LiF@Pol⁺Mono⁻)_{c}), as described above can be coated onto a separator and an electrode.

In some embodiments, the electrochemical device includes the composition in a separator; a separator coating, an electrode coating, an electrode binder, or combinations thereof, wherein the composition includes:
1) a plurality of LiF particles; and
2) a complex comprising poly(diallyldimethylammonium) and 2-acrylamido-2-methyl-1-propane sulfonate
   wherein the complex has a net charge of near zero.

In some embodiments, the electrochemical device is a lithium-ion battery with a carbon-based, metallic, or metalloid anode and a metal oxide or conversion cathode.

### V. EXAMPLES

### Example 1: Synthesis of Poly(diallyldimethylammonium) Fluoride (pDADMAF)

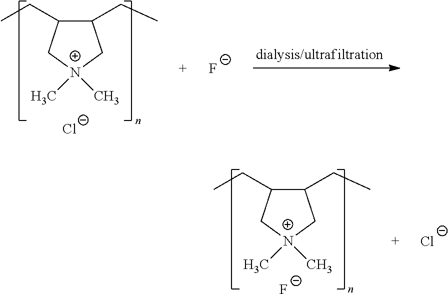

pDADMACl (400K-500K molecular weight) was purchased as a 20% wt solution in water. 200 grams of this 20 wt % solution was added to a 1 L round bottom flask. The water was removed using a roto-evaporator with a bath temperature set to 60 ° C. The flask was further dried on Schlenk line (100 mtorr) for 18 hours. The contents of the flask were then redissolved with vigorous stirring in 600 mL of methanol. To this solution was added 1 equivalent of potassium fluoride (14.37 grams) as solid. The contents of the flask were stirred for 3 hours inducing the precipitation of potassium chloride. The mixture was transferred to falcon tubes and centrifuged for 10 minutes at 4400 rpm. The polymer solution was transferred back to the 1 L flask. Two more precipitation and centrifugation steps were performed in the same manner as just described. The final solution was returned to a round bottom flask and the methanol was evaporated under reduced pressure. The solid material was then re-dissolved in 1 liter of deionized water, and the solution was dispensed into dialysis tubing with 12-14K MWCO. The polymer was dialyzed against a circulating bath of aqueous KF (39 L, 1.06 M) until measurements of the contents of the dialysis tubing showed the ratio of [F⁻]: [Cl⁻] to be >99.5:0.5 as measured by ion selective electrodes. At this point, the tubes were transferred to a deionized water bath and dialyzed against deionized water, which was periodically refreshed. The dialysis was stopped when the ratio of ([F⁻]+[Cl⁻]):[K⁺] was >99.5:0.5, as determined by ion selective electrode measurements. The tubes were emptied, and the water was evaporated under reduced pressure. The solid was re-dissolved in methanol to yield a 10.6 wt % solution of pDADMAF, which was determined by quantification of the fluoride concentration in the final solution.

### Example 2: Synthesis of A Composition Including LiF@pDADMA-AMPS

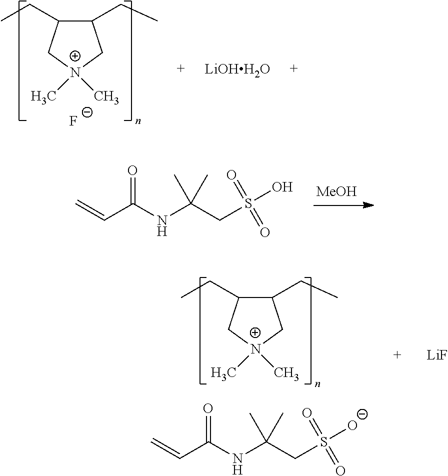

To 48.6 grams of a 10.6 wt % solution of pDADMAF (5.15 g, 35.46 mmol) in a plastic flask was added 1 equivalent of 2-acrylamido-2-methyl-1-propanesulfonic acid (AMPS) (7.35 g, 35.46 mmol). The solution was stirred at room temperature until the AMPS fully dissolved. At this point, 1 equivalent of lithium hydroxide hydrate, (1.49 g, 35.46 mmol) was added slowly as a solid. The addition of lithium hydroxide induced the precipitation of LiF, which remained suspended in the ink. The weight percent of the final LiF@pDADMA-AMPS ink in methanol is 21.3 wt %. If necessary, this solution can be further diluted with more methanol to the desired concentration.

### Example 3: Coating the Composition Including LiF@pDADMA-AMPS on Porous Support

A 6 wt % solution of LiF@pDADMA-AMPS was coated onto Celgard 1611 using a 20 um Meyer rod. One milliliter of the ink was dispersed across the Celgard and the Meyer rod was drawn down at a rate of 2.5 cm/s. The coated Celgard was air dried and the sections were punched to determine the areal mass loading, which is a 150 μg/cm². The coating areal mass loading can be controlled by adjusting the wt % of the LiF@pDADMA-AMPS ink. The coated membranes were dried under high vacuum at 70° C. for 18 hours prior to being brought into an argon filled glovebox.

In some instances, a photoinitiator, Irgacure 2100, was added to the LiF@pDADMA-AMPS ink in amount varying from 1-5 wt % with respect to mass of LiF@pDADMA-AMPS. After coating and air drying, the separator was exposed to UV light (365 nm) for 40-60 mins. The UV cured membranes were dried under high vacuum at 70° C. for 18 hours prior to being brought into an argon filled glovebox.

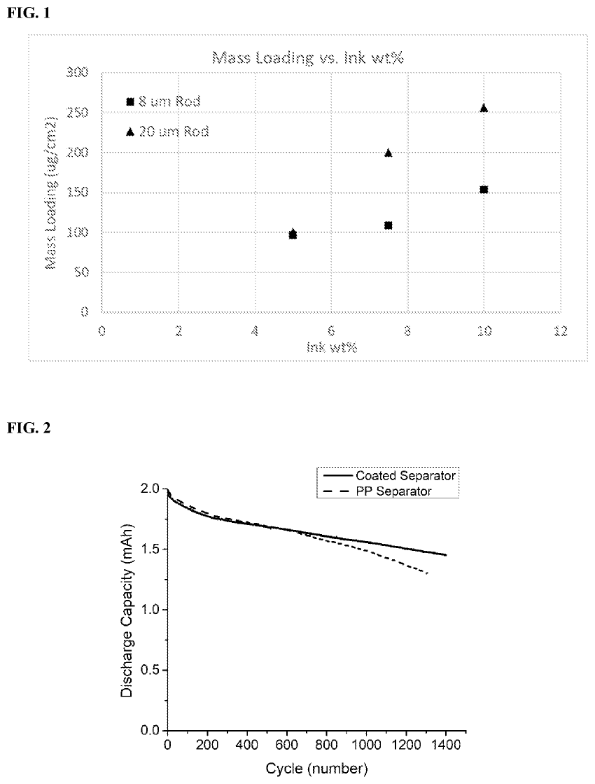

The above prepared LiF polyelectrolyte ink, LiF@pDADMA-AMPS, was coated onto a polyolefin battery separator using Meyer rods. FIG. 1 shows mass loading of the LiF polyelectrolyte ink at various weight concentrations of the LiF@pDADMA-AMPS in the composition.

### Example 4: Coin Cell Builds with the Composition including LiF@pDADMA-AMPS Coated on Porous Polyolefin Battery Separator

Coin cell (2032) were built with an NMC-622 cathode, a graphite anode, and a Celgard 1611 separator which was coated as described above. Uncoated Celgard separators were also included in a separate batch of cells as a control. An electrolyte composed of 1 M LiPF6 in a 1:1 ratio of EC:DEC with the addition of 1 wt % VC was added to the coin cell prior to sealing. The cells were cycled from 3-4.2 V at 25° C., using a CC/CV charge (1 C/0.05 C) and a CC discharge (1 C). FIG. 2 shows comparison of discharge capacity versus numbers of cycles for coin cells, which were fabricated with either an uncoated separator or a separator coated with the composition including LiF@pDADMA-AMPS.

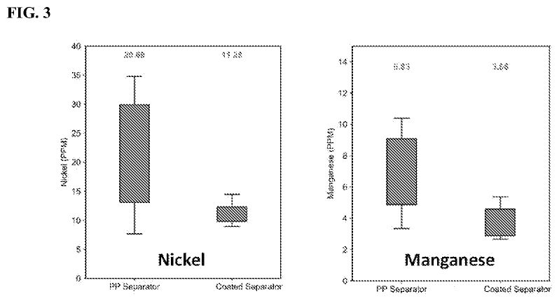

After cycling, the cells were disassembled, and the anodes were digested with concentrated nitric acid. The concentration of nickel and manganese at the anode were determined by ICP. These concentrations were strongly inversely correlated with the retained specific capacity at end of life. The cells containing the LiF@pDADMA-AMPS coated separators consistently showed lowest transition metal concentrations at the anode and therefore the greatest specific capacity, as shown in FIG. 3.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A composition comprising:
1) an inorganic salt comprising a metal ion having a charge of at least +1 and an anion having a charge of at least −1; and
2) a complex comprising a first species and a second species,
wherein:
the first species is a positively charged polymerizable monomer or a first charged polymer comprising one or more positively charged monomer repeat units;
the second species is a negatively charged polymerizable monomer or a second charged polymer comprising one or more negatively charged monomer repeat units; and
the complex has a net charge of near zero.

2. The composition of claim 1, wherein at least a portion of the inorganic salt is a plurality of particles.

3. The composition of claim 1 or 2, wherein the metal ion is an alkali metal cation or an alkali earth metal cation.

4. The composition of any one of claims 1 to 3, wherein the metal ion is Li⁺.

5. The composition of any one of claims 1 to 4, wherein the anion is halide.

6. The composition of any one of claims 1 to 5, wherein the anion is F⁻.

7. The composition of any one of claims 1 to 6, wherein the inorganic salt is LiF.

8. The composition of claim 7, wherein at least a portion of LiF is a plurality of LiF particles.

9. The composition of any one of claims 1 to 8, wherein the first charged polymer comprises one or more quaternary ammonium groups, pyridinium groups, bipyridinium groups, imidazolium groups, protonated amine groups, sulfonium groups, phosphonium groups, or combinations thereof.

10. The composition of any one of claims 1 to 9, wherein the first charged polymer comprises one or more positively charged monomer repeat units in an amount of 20% to 90% by mole.

11. The composition of claim 9 or 10, wherein the first charged polymer is poly(diallyldimethylammonium) (PDADMA), poly(vinylbenzyltrimethylammonium) (PVBTA), poly(acryloxyethyltrimethyl ammonium), poly(methacryloxy(2-hydroxy)propyltrimethyl ammonium), poly(N-methylvinylpyridinium) (PMVP), poly(N-alkylvinylpyridinium), poly(allylamine) (PAH), poly(ethyleneimine) (PEI), or copolymers thereof.

12. The composition of claim 11, wherein the first charged polymer is poly(diallyldimethylammonium).

13. The composition of any one of claims 1 to 8, wherein the positively charged polymerizable monomer is diallyldimethylammonium, vinylbenzyltrimethylammonium, acryloxyethyltrimethyl ammonium, methacryloxy(2-hydroxy)propyltrimethyl ammonium, N-methylvinylpyridinium, N-alkylvinylpyridinium, allylaminium, or aziridinium.

4. The composition of any one of claims 1 to 13, wherein the second charged polymer comprises one or more sulfonate groups, carboxylate groups, phosphate groups, phosphonate groups, or combinations thereof.

15. The composition of any one of claims 1 to 14, wherein the second charged polymer comprises one or more negatively charged monomer repeat units in an amount of 20% to 80% by mole.

16. The composition of claim 14 or 15, wherein the second charged polymer is poly(styrenesulfonate) (PSS), poly(-acrylamido-2-methyl-1-propane sulfonate) (PAMPS), sulfonated poly(ether ether ketone) (SPEEK), poly(ethylenesulfonate), poly(methacryloxyethylsulfonate), poly(acrylate) (PAA), poly(methacrylate), polyphosphates, polyphosphonates, or copolymers thereof.

17. The composition of any one of claims 1 to 13, wherein the negatively charged polymerizable monomer is styrenesulfonate, 2-acrylamido-2-methyl-1-propane sulfonate, sulfonated hydroquinone or difluorobenzophenone, ethylenesulfonate, methacryloxyethylsulfonate, acrylate, or methacrylate.

18. The composition of claim 17, wherein the negatively charged polymerizable monomer is 2-acrylamido-2-methyl-1-propane sulfonate.

19. The composition of any one of claims 1 to 8, wherein the first charged polymer and the second charged polymer are each an amphiphilic polymer comprising one or more positively charged monomer repeat units and one or more negatively charged monomer repeat units, wherein the amphiphilic polymer has a net charge of zero.

20. The composition of claim 19, wherein
the one or more positively charged monomer repeat units are diallyldimethylammonium, vinylbenzyltrimethylammonium, acryloxyethyltrimethyl ammonium, methacryloxy(2-hydroxy)propyltrimethyl ammonium, N-methylvinylpyridinium, N-alkylvinylpyridinium, allylaminium, or aziridinium; and
the one or more negatively charged monomer repeat units are styrenesulfonate, 2-acrylamido-2-methyl-1-propane sulfonate, sulfonated hydroquinone or difluorobenzophenone, ethylenesulfonate, methacryloxyethylsulfonate, acrylate, or methacrylate.

21. The composition of any one of claims 1 to 8, wherein the first charged polymer and second charged polymer are covalently cross-linked.

22. The composition of claim 1, wherein the composition comprises:
1) a plurality of LiF particles; and
2) a complex comprising poly(diallyldimethylammonium) and 2-acrylamido-2-methyl-1-propane sulfonate,
wherein the complex has a net charge of near zero.

23. An electrochemical device comprising a composition according to any one of claims 1 to 22 in a separator, a separator coating, an electrode coating, an electrode binder, or combinations thereof.

24. The electrochemical device of claim 23, wherein electrochemical device is a lithium-ion battery with a carbon-based, metallic, or metalloid anode and a metal oxide or conversion cathode.
